(19) United States
(12) Patent Application Publication
(10) Pub. No.: US 2024/0222925 A1
(43) Pub. Date: Jul. 4, 2024

(54) ELECTRONIC DEVICE ASSEMBLY METHOD

(71) Applicant: NACHI-FUJIKOSHI CORP., Tokyo (JP)

(72) Inventor: Terumasa SAWATO, Toyama (JP)

(73) Assignee: NACHI-FUJIKOSHI CORP., Tokyo (JP)

(21) Appl. No.: 18/427,818

(22) Filed: Jan. 31, 2024

(30) Foreign Application Priority Data
Aug. 4, 2021 (JP) 2021-128146

(51) Int. Cl. H01R 43/26; H01R 12/70; H01R 12/79

(52) U.S. Cl. CPC H01R 43/26; H01R 12/7005; H01R 12/79

(57) ABSTRACT

To provide an electronic device assembly method capable of positioning a cable in the height direction easily and precisely and connecting the cable to a connector easily and reliably. An electronic device assembly method of the present invention is such that a leading end of a flexible flat cable is inserted into a connector attached to a circuit board using a robot including a gripping device gripping the cable, the method including: disposing a guide member in front of an opening of the connector on the circuit board as the guide member facing the opening, the guide member restricting the leading end in a thickness direction of the cable toward the opening; gripping the cable using the gripping device; and inserting the leading end into the connector via the guide member.

### FIELD OF THE INVENTION

The present invention relates to an electronic device assembly method in which a leading end of a flexible flat cable is inserted into a connector attached to a circuit board, with use of a robot including a gripping device that grips the cable.

### BACKGROUND OF THE INVENTION

In assembly of an electronic device, connection work for connecting a leading end of a flat soft (flexible) cable such as an FPC (Flexible Printed Circuit) or an FFC (Flexible Flat Cable) to a connector (substrate-side connector), which is a connection target, on a circuit board or the like is performed. Conventionally, there have been cases where such connection work for connecting a cable is performed manually. However, the work efficiency does not improve when the connection work is performed manually, and therefore, recent years have seen electronic device assembly apparatuses being used.

For example, a holding tool included in an electronic device assembly apparatus described in Patent Document 1 attaches an attachment portion of a cable to a connector of an electronic device held on a work stage. The cable holding tool includes: a contact portion that comes into contact with a surface of the cable; a suction device that is provided in a lower surface of the contact portion and holds the cable that is in contact with the contact portion, through vacuum suction; and a widthwise restriction device constituted by a pair of chucks that restrict the position of the cable in a width direction relative to the suction device by sandwiching the cable in the width direction.

### PRIOR ART DOCUMENT

### Patent Document

Patent Document 1: Japanese Patent Application Laid-open No. 2020-151790

### SUMMARY OF THE INVENTION

### Problems to be Solved by the Invention

In the electronic device assembly apparatus described in Patent Document 1, the chucks restrict the position of the cable in the width direction relative to the suction device. Also, when inserting the cable into the connector, the electronic device assembly apparatus described in Patent Document 1 brings the cable held by the electronic device assembly apparatus closer to the connector and attaches a leading end of the cable to the connector while checking their positions by taking images of the leading end of the cable and the connector from above with use of a camera.

However, the cable is very thin in the up-down direction, and an opening in the connector is also very narrow. On the other hand, when images are taken from above, displacement in the left-right direction can be clearly recognized, but recognition accuracy is low for displacement in the up-down direction, which is a perspective direction. Even if a 3D camera is used, errors in the up-down direction are larger than errors in the left-right direction, and there is a risk that the leading end of the cable may not enter the connector or may be damaged by colliding with an edge of an opening in the connector.

In view of the above problems, the present invention has an object of providing an electronic device assembly method that makes it possible to position a cable in the height direction easily and precisely and connect the cable to a connector easily and reliably.

### Means to Solve the Problem

In order to solve the above problems, a representative configuration of an electronic device assembly method according to the present invention is an electronic device assembly method in which a leading end of a flexible flat cable is inserted into a connector attached to a circuit board, with use of a robot including a gripping device that grips the cable, the method including: disposing a guide member in front of an opening of the connector on the circuit board in such a manner that the guide member faces the opening, the guide member restricting the leading end of the cable in a thickness direction of the cable toward the opening of the connector; gripping the cable with use of the gripping device; and inserting the leading end of the cable into the connector via the guide member.

It is preferable that the guide member is fixed in front of the connector on the circuit board. In a case where the guide member is to be left on the circuit board, the guide member may be bonded or soldered. In a case where the guide member is to be removed after the cable is connected, the guide member may be fixed with a piece of double-sided tape or an adhesive with weak adhesivity. In a case where the guide member is temporarily fixed during the connection work for connecting the cable, the guide member may be supported by a robot arm.

It is preferable that the guide member is supported by a leading end of the gripping device. In this case, the guide member can be fixed (temporarily fixed) in front of the connector at the same time as the cable is brought closer to the connector.

It is preferable that the guide member has a frame shape in which one of a pair of lateral sides is open as viewed in a direction in which the cable is inserted. In this case, it is possible to remove the guide member from the cable in a lateral direction after the cable is connected.

It is preferable that the guide member includes a guide-side opening through which the leading end of the cable is passed, and an inlet side of the guide-side opening has a height that is higher than a height of an outlet side of the guide-side opening, and the height of the guide-side opening gradually decreases from the inlet side toward the outlet side.

### Effects of the Invention

According to the present invention, it is possible to provide an electronic device assembly method that makes it possible to position a cable in the height direction easily and precisely and connect the cable to a connector easily and reliably.

### BRIEF EXPLANATION OF THE DRAWINGS

FIG. 1 is an overall configuration diagram of a robot system including an electronic device assembly apparatus that executes an electronic device assembly method according to an embodiment of the present invention.

FIG. 2 is a diagram showing a part of the electronic device assembly apparatus shown in FIG. 1.

FIG. 3 is a block diagram showing functions of the robot system shown in FIG. 1.

FIG. 4A is a diagram showing a gripping device as viewed obliquely from below.

FIG. 4B is a diagram showing a state where a cable is gripped by the gripping device.

FIG. 5A is a perspective view of a circuit board and a cable placed on the circuit board.

FIG. 5B is a top view of FIG. 5A.

FIG. 5C is a side view of FIG. 5A.

FIG. 5D is a side view of a guide member.

FIG. 6A shows a state where the guide member is fixed in front of a connector.

FIG. 6B shows a state where a leading end of the cable is inserted into the guide member.

FIG. 6C shows a state where the leading end of the cable is guided by an inner wall of a guide-side opening.

FIG. 6D shows a state where the leading end of the cable is inserted into the connector.

FIG. 6E shows a state where the guide member has been removed from the circuit board.

FIG. 7A is a diagram showing a second embodiment of the electronic device assembly method according to the present invention.

FIG. 7B shows a state where the gripping device is moved toward the connector.

### EMBODIMENTS OF THE INVENTION

Preferred embodiments of the present invention are described below in detail with reference to the attached drawings. Dimensions, materials, other specific numerical values, and the like described in the embodiments are merely examples for facilitating understanding of the present invention, and do not limit the present invention unless otherwise stated. In the specification and the drawings, elements that have substantially the same function and configuration are denoted by the same reference numeral, and a redundant description of such elements is omitted. Also, illustration of elements that do not directly relate to the present invention is omitted.

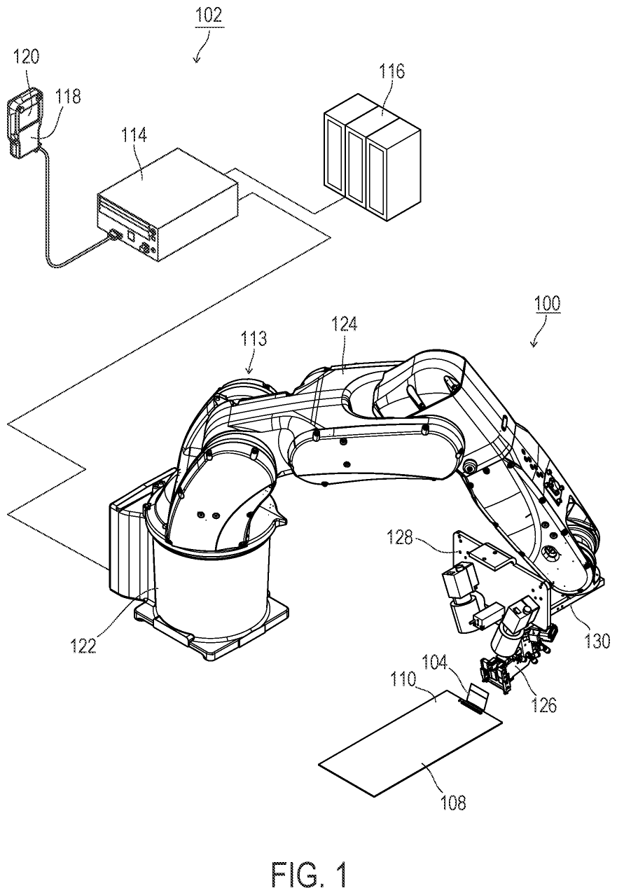

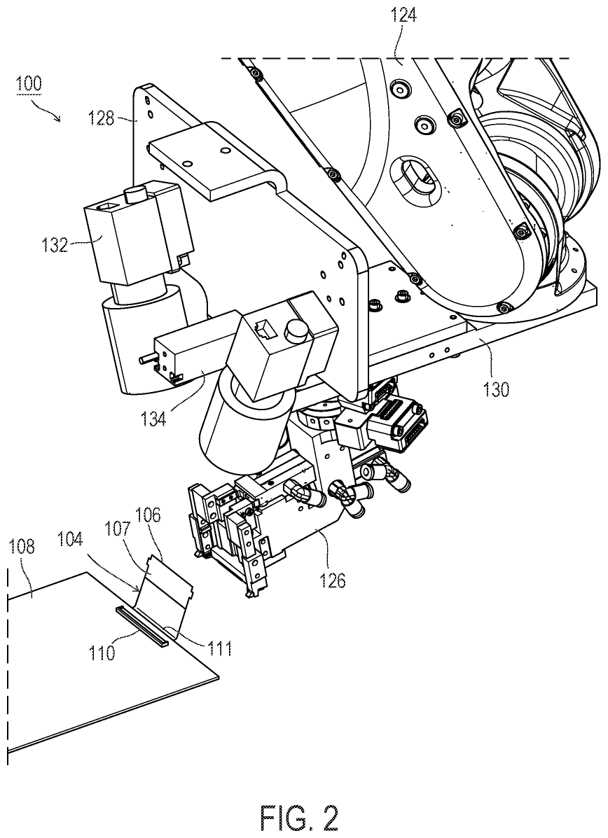

FIG. 1 is an overall configuration diagram of a robot system 102 including an electronic device assembly apparatus 100 that executes an electronic device assembly method according to an embodiment of the present invention. FIG. 2 is a diagram showing a part of the electronic device assembly apparatus 100 shown in FIG. 1. The electronic device assembly apparatus 100 is used at a production site such as a plant, and automatically performs connection work for connecting (inserting) a leading end 106 of a cable shown in FIG. 2 to a connector 110 on a circuit board 108, which is a connection target. The cable 104 is a flat elongated cable having flexibility such as an FPC or an FFC.

The electronic device assembly apparatus 100 includes a robot body 113 shown in FIG. 1 and a robot controller 114 connected to the robot body 113. The robot system 102 includes an upper-level control system 116, an input device 118, and a state notification device 120 that are connected to the robot controller 114, in addition to the electronic device assembly apparatus 100. The input device 118 is a device for inputting commands, parameters, and the like to the robot controller 114. The state notification device 120 is a device that receives and displays an operation state of the robot body 113 and a state of the connection work, which are transmitted from the robot controller 114.

The robot body 113 includes a base 122 shown in FIG. 1, a robot arm 124 connected to the base 122, a gripping device 126, and a visual device 128. The gripping device 126 is attached to a leading end 130 of the robot arm 124 as shown in FIG. 2 and grips the cable 104.

As shown in FIG. 2, the visual device 128 is an imaging device that captures images of the cable 104 and the like. The visual device 128 is attached so as to face downward toward the leading end 130 of the robot arm 124. The visual device 128 includes a camera 132, which is a visual sensor, and a lighting device 134 that lights up the circuit board 108 and the cable 104.

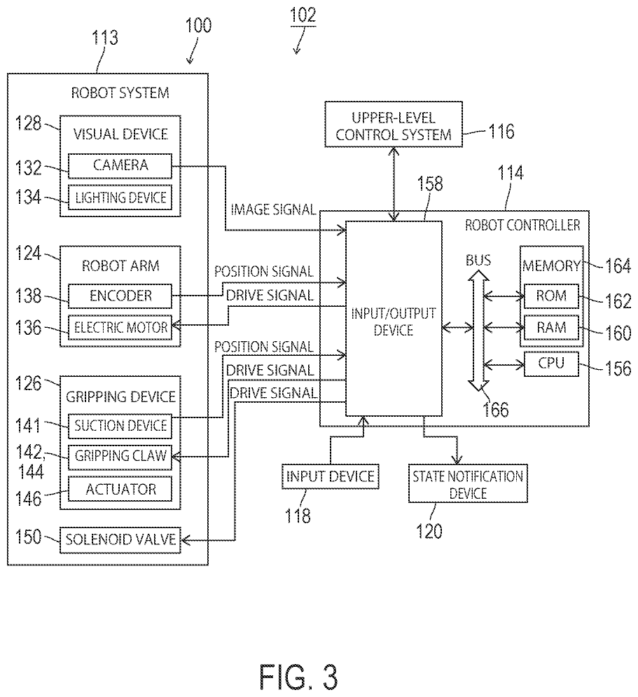

FIG. 3 is a block diagram showing functions of the robot system 102 shown in FIG. 1. The robot arm 124 is a six-axis vertical articulated robot, and includes electric motors 136, which are actuators provided at joints of the robot arm, and encoders 138 that detect positions of the joints. The encoders 138 output position signals indicating detection results of the positions of the joints to the robot controller 114.

The robot controller 114 generates drive signals for driving the electric motors 136 based on the position signals received from the encoders 138. The electric motors 136 are driven by the drive signals output from the robot controller 114 and realize target operations of the robot arm 124 in the connection work.

With this configuration, the robot arm 124 can move the gripping device 126 attached to its leading end 130 as shown in FIG. 2 to a predetermined position. Note that the robot arm 124 is not limited to a six-axis vertical articulated robot, and may also be a vertical articulated robot in which the number of axes is not six, or a horizontal articulated robot, for example.

The camera 132 and the lighting device 134 included in the visual device 128 are attached to the leading end 130 of the robot arm 124 (see FIG. 1). However, there is no limitation to this configuration, and the camera and the lighting device may be provided at a position other than the robot body 113 so long as an overhead image of a work area of the connection work can be obtained. At least one camera 132 needs to be provided, and it is preferable to provide two or more cameras in order to enhance imaging precision. The camera 132 may obtain color images or monochrome images.

In the case where the camera 132 is a monocular camera, three-dimensional imaging information can be estimated with use of known SLAM (Simultaneous Localization and Mapping) technology. However, in this case, the camera 132 needs to be moved while taking images. Note that, in principle, the camera 132 can obtain only a relative value of distance, but when positional information of the camera 132 can be obtained from the robot control device controller 114, it is possible to obtain positional information in a robot coordinate system.

In the case where the camera 132 is a stereo camera, positional information can be obtained from parallax information obtained through known stereo matching. In the case where the camera 132 is a multi-view camera, the principle is the same as that of the stereo camera, and parallax images taken from various directions can be obtained, and therefore, occlusion is unlikely to occur. In the case where the camera 132 is a TOF (Time of Flight) camera, positional information can be obtained based on the time it takes to receive light reflected from a subject after the light is emitted toward the subject. In the case where the camera 132 uses emitted light, positional information can be obtained by performing known pattern projection (projection of a stripe pattern or a random dot pattern).

The lighting device 134 is installed in a surrounding region of a lens of the camera 132 for capturing images, for example, and lights up the cable 104 to be gripped by the gripping device 126 and the connector 110 on the circuit board 108 to which the cable is to be connected. However, there is no limitation to this configuration, and the lighting device may also emit pattern light when measuring a distance.

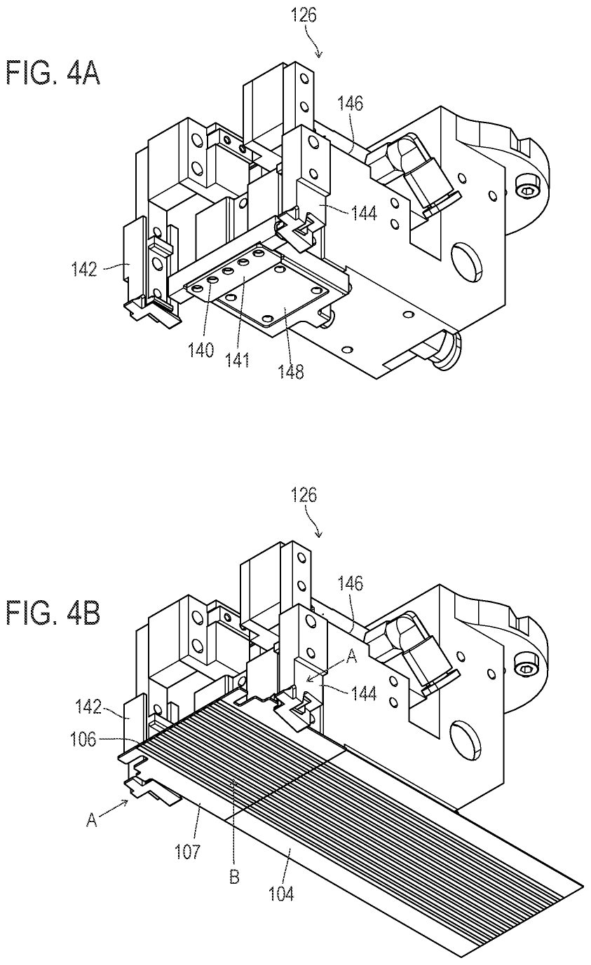

FIG. 4A is a diagram showing the gripping device 126 as viewed obliquely from below, and FIG. 4B is a diagram showing a state where the cable 104 is gripped by the gripping device 126. As shown in FIG. 4A, the gripping device 126 includes: a suction device 141 including a plurality of suction holes 140; a pair of gripping claws 142 and 144; and an actuator 146.

As shown in FIGS. 4A and 4(b), the gripping claws 142 and 144 are located outward of the suction device 141 in the width direction and perform opening and closing operations so as to approach each other or separate from each other in response to being driven by the actuator 146. Thus, the gripping claws 142 and 144 hold the cable 104 by sandwiching the cable 104 in the width direction, or release the cable 104.

The suction device 141 is a plate-shaped portion provided in a suction base 148 of the gripping device 126 shown in FIG. 4A, and extends in the width direction, for example. The plurality of suction holes 140 are arranged in a line along the width direction in the suction device 141. The suction device 141 holds the cable 104 by sucking a surface of the cable 104 via the suction holes 140. Although the suction holes 140 are arranged in a line in the illustrated example, there is no limitation to this configuration, and the suction holes 140 may also be arranged in two or more lines. Also, the suction holes 140 need not have a circular shape, and it is sufficient that they have a shape (e.g., an elliptical shape) that prevents air from leaking through gaps between the cable 104 and the suction holes 140 when the cable 104 is sucked.

The suction holes 140 are in communication with a vacuum pressure generating source such as an ejector, and a vacuum is created by feeding compressed air to the ejector using an operation of a solenoid valve 150 shown in FIG. 3. The solenoid valve 150 that controls the suction holes 140 is provided in the robot body 113 as shown in FIG. 3 and operates in response to a drive signal from the robot controller 114. However, there is no limitation to the configuration in which the solenoid valve 150 is provided in the robot body 113, and the solenoid valve 150 may be provided in an element included in the robot system 102.

When the gripping device grips the cable, first, the cable 104 is placed between the pair of gripping claws 142 and 144, and the pair of gripping claws 142 and 144 are moved toward the cable 104 in the direction of arrows A. Thus, the cable 104 is sandwiched by the pair of gripping claws 142 and 144. Then, air is sucked via the suction holes 140 of the suction device 141 to suck the cable 104 in the direction of the arrow B. Thus, the cable 104 is gripped by the gripping device 126 as shown in FIG. 4B.

The following description refers to FIG. 3 again. The robot 1 controller 114 includes a CPU 156, an input/output device 158 for inputting and outputting signals, and a memory 164 including a RAM 160 and a ROM 162. The CPU 156, the input/output device 158, and the memory 164 are connected to each other via a bus 166 in such a manner that signals can be transmitted therebetween.

The CPU 156 functions as an arithmetic processing device, accesses the memory 164, and reads out and executes various programs stored in the RAM 160, the ROM 162, an external storage device, or the like. The RAM 160 and the ROM 162 are computer-readable recording mediums including programs recorded thereon for controlling the robot body 113.

For example, a program and a device constant used by the CPU 156 are stored in the ROM 162. For example, a program used by the CPU 156 and a variable that varies successively during execution of the program are temporarily stored in the RAM 160. As described above, the robot controller 114 can control the robot body 113 and the gripping device 126 by executing various programs and cause the robot body 113 and the gripping device 126 to execute various functions.

The input/output device 158 of the robot controller 114 includes a communication device, a D/A converter, a motor drive circuit, an A/D converter, and the like, and connects the robot controller 114 to an external device, the electric motors 136, the actuator 146, and various sensors such as the encoders 138 via an interface.

Examples of specific communication methods used by the communication device may include data communication in accordance with serial communication standards such as RS232C/485 or USB standards, EtherNET (registered trademark), which is a common network protocol, and EtherCAT (registered trademark) and EtherNet/IP (registered trademark), which are used as industrial network protocols.

The robot controller 114 may also be connected via the input/output device 158 to a storage device for storing data or a drive device that is a reader-writer for recording mediums. The robot controller 114 is not limited to a controller in which dedicated hardware is incorporated, and may also be a general-purpose personal computer that can execute various functions when various programs are installed, for example.

Note that the robot controller 114 controls all of the robot arm 124, the gripping device 126, and the visual device 128, but there is no limitation to this configuration. For example, the robot controller 114 may be configured as a group of a plurality of controllers that respectively control the robot arm 124, the gripping device 126, and the visual device 128, and the plurality of controllers may be connected to each other wirelessly or by cable. Furthermore, the robot controller 114 is provided outside the robot body 113 in the electronic device assembly apparatus 100, but there is no limitation to this configuration, and the robot controller 114 may also be provided inside the robot body 113.

The input device 118 includes an operation means to be operated by a user, such as a keyboard, a mouse, a touch panel, a button, a switch, a lever, a pedal, a remote control means that uses infrared rays or other radio waves, or a personal computer or teaching pendant including these devices. The user who performs the connection work uses the input device 118 to perform input and setting. Note that a program that causes the robot body 113 to execute various functions may be created with use of the input device 118. The program may be written in a low level language such as a machine language or a high level language such as a robot language.

The state notification device 120 receives information regarding an operation state of the robot body 113 and information regarding a state of the leading end 106 of the cable inserted into the connector 110 on the circuit board 108 from the robot controller 114 and displays the information to enable the user to recognize the information visually and intuitively. The state notification device 120 may be a display device such as a liquid crystal panel, a teaching pendant, or a lighting lamp, or a notification device that gives notifications regarding information with use of an alert sound or audio.

For example, the state notification device 120 may be set so as to issue an alert when the connection work for inserting the leading end 106 of the cable into the connector 110 has failed. Alternatively, a screen of a personal computer or a teaching pendant may serve as the state notification device 120. The state notification device 120 may include an application for performing input and notification of states.

The upper-level control system 116 is constituted by, for example, a sequencer (PLC), a monitoring and control system (SCADA), a process computer (PROCOM), a personal computer, various servers, or a combination thereof, and connected to the robot controller 114 wirelessly or by cable. The upper-level control system 116 outputs instructions based on operation states of devices that constitute a production line including the robot controller 114, and comprehensively controls the production line.

The upper-level control system 116 can also be used to monitor a defect rate or a cycle time or inspect products by receiving and collecting the time it takes to complete the connection work, a state after the connection work is complete, or the like from the robot controller 114. Furthermore, the upper-level control system 116 may obtain information regarding a state of the operation for gripping the cable 104 with the gripping device 126 of the robot body 113 from the robot controller 114 to cause the robot arm 124 to return to a home position or stop each device.

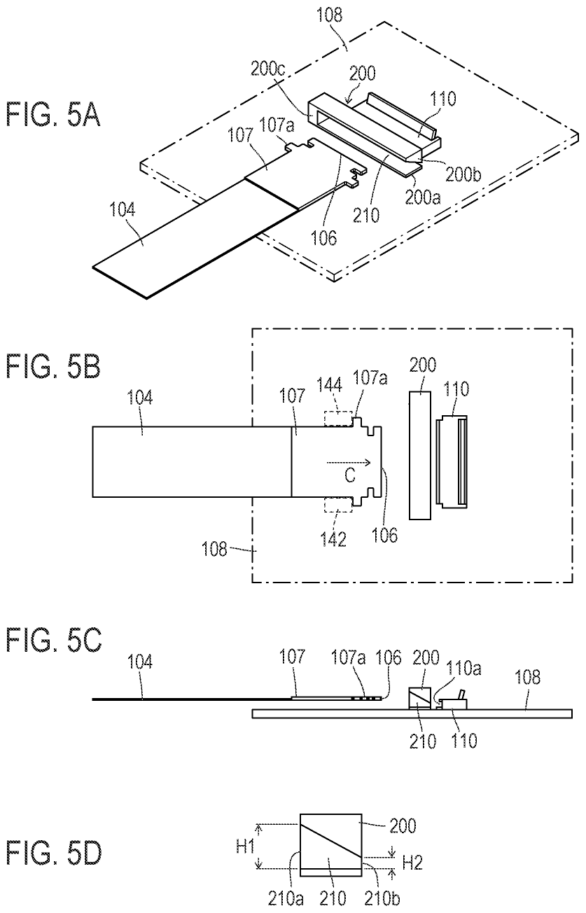

FIG. 5A is a perspective view of the circuit board 108 and the cable 104 placed on the circuit board. FIG. 5B is a top view of FIG. 5A. FIG. 5C is a side view of FIG. 5A. FIG. 5D is a side view of a guide member 200.

In an electronic device assembly method described below, the leading end 106 of the flexible flat cable 104 is inserted into the connector 110 attached to the circuit board 108, with use of a robot including the gripping device 126 (the gripping device 126 of the robot body 113) that grips the cable 104.

As shown in FIGS. 5A to 5(c), a reinforcing plate 107 is attached to the cable in the vicinity of the leading end 106, and protrusions 107a (tabs) are formed on two sides of the reinforcing plate 107. The gripping claws 142 and 144 of the gripping device 126 are placed behind the protrusions 107a as shown in FIG. 5B, and when the gripping claws 142 and 144 are moved in the direction of the arrow C, the cable 104 moves toward the connector 110.

In the present embodiment, a configuration is described as an example in which the protrusions 107a (tabs) are formed on two sides of the reinforcing plate 107, but there is no limitation to this configuration. Even if the reinforcing plate 107 does not have the protrusions 107a, it is possible to insert the leading end 106 of the cable (the reinforcing plate 107) into a connector-side opening 110a of the connector 110 by gripping the cable 104 with use of the gripping device 126 in which the gripping claws 142 and 144b sandwich the cable 104 and the suction device 141 sucks air via the suction holes 140.

### First Embodiment

In an electronic device assembly method according to a first embodiment, the guide member 200 shown in FIGS. 5A to 5D is used. The guide member 200 restricts the leading end 106 of the cable 104 in the thickness direction (a height direction or an up-down direction) of the cable 104 toward an opening (the connector-side opening 110a shown in FIG. 5C) of the connector 110.

Specifically, the connector-side opening 110a into which the leading end 106 of the cable is inserted is formed in the connector 110 as shown in FIG. 5C. On the other hand, a guide-side opening 210 through which the leading end 106 of the cable is passed is formed in the guide member 200. As shown in FIG. 5A, the guide member 200 is constituted by a base 200a that is in contact with the circuit board 108, an upper side 200b that opposes the base 200a, and a lateral side 200c connecting the base 200a and the upper side 200b, and a space surrounded by these is the guide-side opening 210. The guide member has only one lateral side 200c. That is, the guide member 200 has a frame shape in which one of a pair of lateral sides 200c is open.

As shown in FIG. 5D, an outlet side 210b (a side facing the connector 110) of the guide-side opening 210 has a height H2 that is substantially the same as or lower than the height of the connector-side opening 110a and larger than the thickness of the leading end 106 of the cable. An inlet side 210a of the guide-side opening 210 has a height H1 that is larger than the height H2 of the outlet side 210b, and the height of the guide-side opening 210 gradually decreases from the inlet side 210a toward the outlet side 210b.

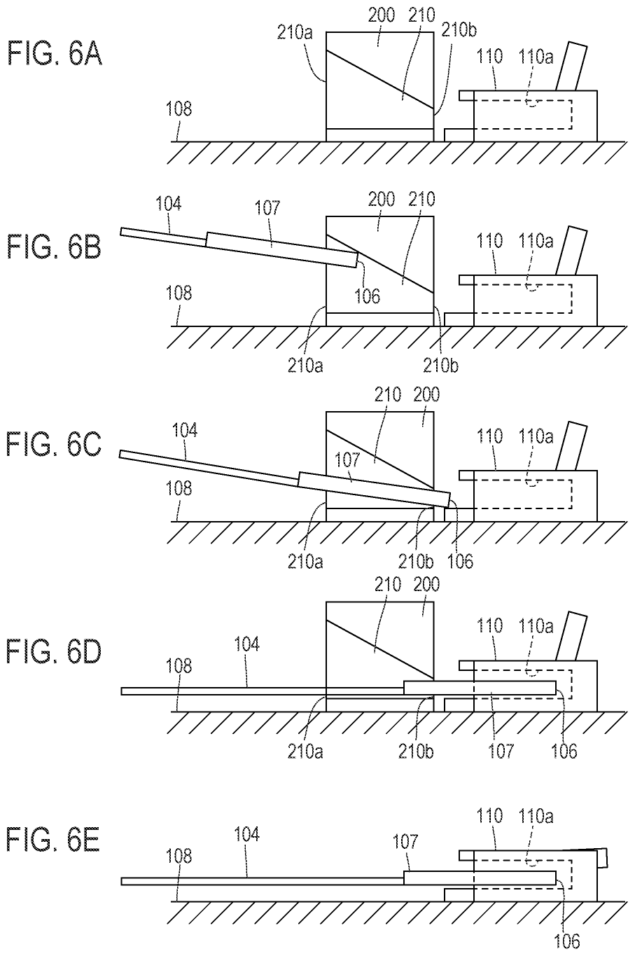

FIGS. 6a to 6E are diagrams showing the first embodiment of the electronic device assembly method according to the present invention. Members that need not be illustrated to describe the electronic device assembly method according to the first embodiment are not illustrated in FIGS. 6a to 6E to facilitate understanding.

In the electronic device assembly method according to the first embodiment, first, the guide member 200 is fixed in front of the connector-side opening 110a of the connector 110 on the circuit board 108 so as to face the connector-side opening 110a as shown in FIG. 6A. In a case where the guide member 200 is to be left on the circuit board 108, the guide member 200 may be bonded or soldered. In a case where the guide member 200 is to be removed after the cable is connected, the guide member 200 may be fixed with a piece of double-sided tape or an adhesive with weak adhesivity. In a case where the guide member 200 is temporarily fixed during the connection work for connecting the cable, the guide member 200 may be supported by a robot arm.

Next, the cable 104 is gripped by the gripping device 126 (see FIG. 4B), and the reinforcing plate 107 at the leading end 106 of the cable is inserted into the guide-side opening 210 of the guide member 200 as shown in FIG. 6B. The height H1 of the inlet side 210a of the guide-side opening 210 is larger than the height of the connector-side opening 110a, and this configuration significantly facilitates the insertion.

The cable 104 is moved toward the connector 110 by the gripping device 126 from the state shown in FIG. 6B. Since the cable 104 is flexible, when the cable 104 comes into contact with an inner wall of the guide 210, the leading end 106 of the cable moves along the inner wall of the guide 210. Thus, the leading end 106 of the cable is guided by the inner wall of the guide-side opening 210 toward the connector-side opening 110a as shown in FIG. 6C.

Then, the cable 104 is moved further to insert the leading end 106 of the cable 104 into the connector-side opening 110a of the connector 110 via the guide member 200 as shown in FIG. 6D. Thus, the cable 104 is connected to the circuit board 108 via the connector 110.

As described above, in the electronic device assembly method according to the first embodiment, the inlet side 210a of the guide-side opening 210 of the guide member 200 has the height H1 larger than the height of the connector-side opening 110a of the connector 110. Also, the height H2 of the outlet side 210b of the guide-side opening 210 is substantially the same as or lower than the height of the connector-side opening 110a of the connector 110 and larger than the thickness of the leading end 106 of the cable. With this configuration, the leading end 106 of the cable (the reinforcing plate 107) is guided by the guide member 200 and inserted into the connector-side opening 110a of the connector 110.

In the above configuration, the leading end 106 of the cable is positioned in the height direction by the guide member 200. That is, even if the height or posture of the leading end 106 of the cable shifts somewhat, the height or posture of the leading end is corrected by the guide member 200. Therefore, when compared with a case where the leading end 106 of the cable is directly inserted into the connector-side opening 110a, it is possible to connect the cable 104 to the connector 110 and the circuit board 108 more easily and reliably.

Note that the guide member 200 may be fixed in front of the connector 110 on the circuit board 108 in the state shown in FIG. 6A and may be left there after the cable is connected. In this case, there is no need to remove the guide member 200 from the circuit board 108.

Alternatively, the guide member 200 may be removed from the circuit board 108 as shown in FIG. 6E after the connection work for connecting the cable 104 to the connector 110 is completed. In this case, the guide member 200 can be removed from the cable 104 because the guide member 200 has a frame shape in which one of a pair of lateral sides is open (i.e., the guide-side opening 210 is open on the left side or the right side) when viewed in the direction in which the cable 104 is inserted as shown in FIG. 5A. However, in the case where the connector 110 is left on the circuit board 108 as described above, the guide member 200 may have a frame shape that is constituted by four sides (an upper side, a base, and a pair of lateral sides) when viewed in the direction in which the cable 104 is inserted.

### Second Embodiment

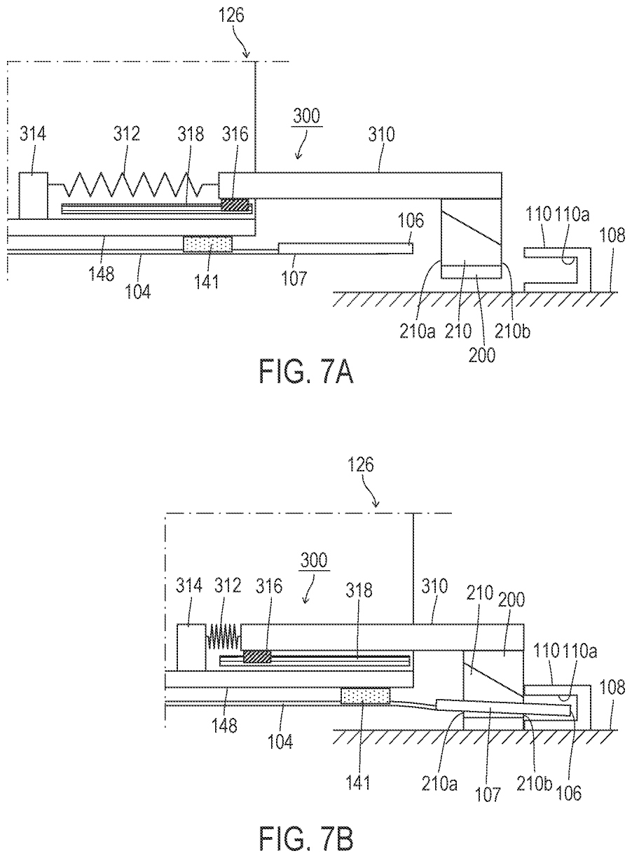

FIG. 7A is a diagram showing a second embodiment of the electronic device assembly method according to the present invention. In the first embodiment, the guide member 200 is disposed (fixed) in front of the connector 110 on the circuit board 108. In contrast, in the second embodiment, the guide member 200 is supported by a leading end 106 of the gripping device 126. Note that the gripping device 126 has been described in detail with reference to FIG. 4, and therefore, descriptions and illustration of members that need not be described in the second embodiment are omitted.

In the second embodiment, the guide member 200 is supported by the leading end of the gripping device 126 via a bridge 310 of an attachment 300 shown in FIGS. 7A and 7B. A travel block 316 is attached to a lower surface of the bridge 310. The travel block 316 travels on a travel rail 318 disposed on an upper surface of the suction base 148 included in the gripping device 126. With this configuration, the bridge 310 is supported in such a manner as to be slidable relative to the gripping device 126.

An end of a spring 312 is connected to a rear end of the bridge 310, and another end of the spring 312 is connected to a support block 314 coupled to the upper surface of the suction base 148 included in the gripping device 126. The spring 312 is a compression spring, and the bridge 310 is biased forward from the gripping device 126.

When the cable 104 is gripped by the gripping device 126 described above, the guide member 200 is disposed in front of the cable 104 as shown in FIG. 7A. That is, the guide member is disposed in such a manner that the guide-side opening 210 is located on the path of the cable 104. Then, the gripping device 126 is moved toward the connector 110 as shown in FIG. 7B. As a result, the guide member 200 comes into contact with the connector 110 on the circuit board 108 and stops (is fixed by being biased) in front of the connector 110. Thus, the guide member 200 is disposed in front of the connector-side opening 110a of the connector 110 on the circuit board 108 so as to face the connector-side opening 110a similarly to the first embodiment.

When the gripping device 126 is moved further toward the connector 110, the block 316 travels on the travel rail 318 while compressing the spring 312, and the gripping device 126 moves with the guide member 200 stopped. The leading end 106 of the cable is guided by the guide-side opening 210 and inserted into the connector-side opening 110a of the connector 110.

As described above, in the configuration in which the guide member 200 is supported by the leading end of the gripping device 126 as in the second embodiment, it is possible to fix the guide member 200 in front of the connector 110 in the operation for inserting the cable 104 into the connector 110. Therefore, it is possible to obtain effects similar to those obtained by the electronic device assembly method according to the first embodiment without increasing the number of steps involved in the connection work.

This application is based upon and claims the benefit of priority from the prior Japanese Patent Application No. 2021-128146, filed on Aug. 4, 2021, the above contents are cited in the specification, claims, and drawings of the present application.

While preferred embodiments of the present invention have been described with reference to the attached drawings, it goes without saying that the present invention is not limited to the embodiments. It is clear that those skilled in the art will be able to arrive at various changes and modifications within the scope of the claims, and those changes and modifications are understood to naturally fall within the technical scope of the present invention.

### INDUSTRIAL APPLICABILITY

The present invention can be used as an electronic device assembly method in which a leading end of a flexible flat cable is inserted into a connector attached to a circuit board, with use of a robot including a gripping device that grips the cable.

### INDEX TO THE REFERENCE NUMERALS

100 . . . electronic device assembly apparatus; 102 . . . robot system; 104 . . . cable; 106 . . . leading end; 107 . . . reinforcing plate; 107a . . . protrusion; 108 . . . circuit board; 110 . . . connector; 110a . . . connector-side opening; 111 . . . base; 113 . . . robot body; 114 . . . robot controller; 116 . . . upper-level control system; 118 . . . input device; 120 . . . state notification device; 122 . . . base; 124 . . . robot arm; 126 . . . gripping device; 128 . . . visual device; 132 . . . camera; 134 . . . lighting device; 140 . . . suction hole; 141 . . . suction device; 142 . . . gripping claw; 144 . . . gripping claw; 146 . . . actuator; 148 . . . suction base; 150 . . . solenoid valve; 156 . . . CPU; 158 . . . input/output device; 160 . . . RAM; 162 . . . ROM; 164 . . . memory; 166 . . . bus; 200 . . . guide member; 200a . . . base; 200b . . . upper side; 200c . . . lateral side; 210 . . . guide-side opening; 300 . . . attachment; 310 . . . bridge; 312 . . . spring; 314 . . . support block; 316 . . . travel block; 318 . . . travel rail

1: An electronic device assembly method in which a leading end of a flexible flat cable is inserted into a connector attached to a circuit board, with use of a robot including a gripping device that grips the cable, the method comprising:
disposing a guide member in front of an opening of the connector on the circuit board in such a manner that the guide member faces the opening, the guide member restricting the leading end of the cable in a thickness direction of the cable toward the opening of the connector;
gripping the cable with use of the gripping device; and
inserting the leading end of the cable into the connector via the guide member.

2: The electronic device assembly method according to claim 1,
wherein the guide member is fixed in front of the opening of the connector on the circuit board.

3: The electronic device assembly method according to claim 1,
wherein the guide member is supported by a leading end of the gripping device.

4: The electronic device assembly method according to claim 1,
wherein the guide member has a frame shape in which one of a pair of lateral sides is open as viewed in a direction in which the cable is inserted.

5: The electronic device assembly method according to claim 1,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.

6: The electronic device assembly method according to claim 2,
wherein the guide member has a frame shape in which one of a pair of lateral sides is open as viewed in a direction in which the cable is inserted.

7: The electronic device assembly method according to claim 3,
wherein the guide member has a frame shape in which one of a pair of lateral sides is open as viewed in a direction in which the cable is inserted.

8: The electronic device assembly method according to claim 2,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.

9: The electronic device assembly method according to claim 3,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.

10: The electronic device assembly method according to claim 4,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.

11: The electronic device assembly method according to claim 6,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.

12: The electronic device assembly method according to claim 7,
wherein the guide member includes a guide-side opening through which the leading end of the cable is passed, and
an inlet side of the guide-side opening has a height that is larger than a height of an outlet side of the guide-side opening, and the height of the guide-side opening gradually decreases from the inlet side toward the outlet side.
